(19) United States
(12) Patent Application Publication
(10) Pub. No.: US 2024/0135181 A1
(43) Pub. Date: Apr. 25, 2024

(54) SYSTEMS AND METHODS FOR ON-DEVICE VALIDATION OF A NEURAL NETWORK MODEL

(71) Applicant: Samsung Electronics Co., Ltd., Suwon-si (KR)

(72) Inventors: Gokulkrishna M, Bengaluru (IN); Siva Kailash SACHITHANANDAM, Bengaluru (IN); Prasanna R, Bengaluru (IN); Rajath Elias SOANS, Bengaluru (IN); Alladi Ashok Kumar SENAPATI, Bengaluru (IN); Praveen Doreswamy NAIDU, Bengaluru (IN); Pradeep NELAHONNE SHIVAMURTHAPPA, Bengaluru (IN)

(21) Appl. No.: 18/541,972

(22) Filed: Dec. 15, 2023

Related U.S. Application Data
(63) Continuation of application No. PCT/KR2023/011844, filed on Aug. 10, 2023.

(30) Foreign Application Priority Data
Oct. 12, 2022 (IN) 202241058188

(51) Int. Cl. G06N 3/08; G06N 3/045

(52) U.S. Cl. CPC G06N 3/08; G06N 3/045

(57) ABSTRACT

A method for validating a trained artificial intelligence (AI) model on a device is provided. The method includes deploying a validation model generated by applying a plurality of anticipated configurational changes associated with the trained AI model requiring validation. Further, the method includes providing input data to each of the validation model and the trained AI model for receiving an output from each of the validation model and the trained AI model, wherein the output of the validation model is further based on one or more actual configurational deviations that occurred during training of the trained AI model since deployment of the trained AI model on the device. Furthermore, the method includes combining the output of each of the validation model and the trained AI model to validate the trained AI model.

### CROSS-REFERENCE TO RELATED APPLICATION(S)

This application is a continuation application, claiming priority under § 365(c), of an International application No. PCT/KR2023/011844, filed on Aug. 10, 2023, which is based on and claims the benefit of an Indian patent application number 202241058188, filed on Oct. 12, 2022, in the Indian Intellectual Property Office, the disclosure of which is incorporated by reference herein in its entirety.

### BACKGROUND

### Field

The disclosure relates to validation of neural network models. More particularly, the disclosure relates to a system and method for validation of an artificial intelligence (AI) model using a validation model on a device.

### Description of the Related Art

Mobile devices or embedded devices nowadays have multiple sensors that collect an enormous amount of user-generated data which possesses the potential to provide a good insight on user profiles. Fine-tuning or structural changes of a machine learning (ML) model by training over this data from on-device will provide customized experience to the end user which is known as model personalization. Due to popularity of on-device training for personalized experience, there is a growing demand for validation mechanism of the ML models on the device itself, known as on-device validation of ML models.

### SUMMARY

Aspects of the disclosure are to address at least the above-mentioned problems and/or disadvantages and to provide at least the advantages described below. Accordingly, an aspect of the disclosure is provide a system and method for validation of an AI model using a validation model on a device.

Additional aspects will be set forth in part in the description which follows and, in part, will be apparent from the description, or may be learned by practice of the presented embodiments.

In accordance with an aspect of the disclosure, a method for validating a trained artificial intelligence (AI) model on a device is provided. The method includes deploying, at the device, a validation model generated by applying a plurality of anticipated configurational changes associated with the trained AI model requiring validation. Further, the method includes providing, at the device, input data to each of the validation model and the trained AI model for receiving an output from each of the validation model and the trained AI model, wherein the output of the validation model is further based on one or more actual configurational deviations that occurred during training of the trained AI model since deployment of the trained AI model on the device. Furthermore, the method includes combining, at the device, the output of each of the validation model and the trained AI model. Additionally, the method includes validating the trained AI model based on a comparison of the combined output and the output of the trained AI model.

In accordance with another aspect of the disclosure, a system for validating a trained artificial intelligence (AI) model on a device is provided. The system includes a validation model, and at least one controller. The at least one controller is configured to deploy, at the device, the validation model created by applying a plurality of anticipated configurational changes associated with the trained AI model requiring validation. Further, the at least one controller is configured to provide, at the device, input data to each of the validation model and the trained AI model for receiving an output from each of the validation model and the trained AI model, wherein the output of the validation model is further based on a set of actual configurational deviations that occurred during training of the trained AI model since deployment of the trained AI model on the device. Furthermore, the at least one controller is configured to combine, at the device, the output of each of the validation model and the trained AI model. Additionally, the at least one controller is configured to validate the trained AI model based on a comparison of the combined output and the output of the trained AI model.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a schematic block diagram for validating a trained artificial intelligence (AI) model on a device, according to an embodiment of the disclosure;

FIG. 2 illustrates a detailed schematic block diagram of the offline phase of generating a validation neural network for validating a trained artificial intelligence (AI) model on a device, according to an embodiment of the disclosure;

FIGS. 3A and 3B illustrate a deviation feature set and an AI model changes, according to an embodiment of the disclosure;

FIG. 4A illustrates a process flow for functioning of a validation neural network (VNN) based on a set of deviation features, according to an embodiment of the disclosure;

FIG. 4B illustrates a validation neural network being used for validation of an AI model on a device, according to an embodiment of the disclosure;

FIGS. 5A and 5B illustrate detailed schematic block diagrams of the online phase of validating a training of an artificial intelligence (AI) model deployed on a device, according to various embodiments of the disclosure;

FIG. 6 illustrates a schematic block diagram of a system for validating training of an artificial intelligence (AI) model deployed on a device, according to an embodiment of the disclosure;

FIG. 7 illustrates a detailed process flow depicting a method for an offline phase of generating a validation neural network for validating a trained artificial intelligence (AI) model on a device, according to an embodiment of the disclosure;

FIGS. 8A, 8B, and 8C illustrate a more detailed process flow depicting a method for each sub-step of method for an offline phase of generating a validation neural network for validating a trained artificial intelligence (AI) model on a device, according to various embodiments of the disclosure;

FIGS. 9A and 9B illustrate detailed process flows depicting methods of the online or on-device phase of validating a training of an artificial intelligence (AI) model deployed on a device, according to various embodiments of the disclosure; and

FIG. 10 illustrates a detailed process flow depicting method of the offline and online phases for validating a training of an artificial intelligence (AI) model deployed on a device, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skilled in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The term “AI model”, “deep model”, “deep learning model”, “personalized model”, and “on-device neural network model” along with their implied variations have been used interchangeably throughout the disclosure. Further, the terms “deviation feature”, “discrete point”, “feature matrix” and “configurational changes” along with their implied variations have been used interchangeably throughout the disclosure.

Various embodiments of the disclosure are related to systems and methods for an on-device validation of training of an artificial intelligence (AI)/machine learning (ML)/deep neural network-based model without any dataset dependency. Specifically, a validation neural network model is created by applying at least in part the one or more possible configurational changes for the on-device AI/ML/deep neural network model requiring validation. In an embodiment, the validation neural network model may be a lightweight neural network model. Subsequently, for validation of the AI model, on-device input data may be provided to both the lightweight validation neural network model and the AI model, and the output of both the lightweight validation model and the deep model may be combined for validating the training of the AI model. The training of the AI model may be validated as a result of the combined output being higher or lower than a predefined threshold.

Further, the disclosure relates to a method which may calculate and approximate the changes that a deployed AI model may undergo via on-device training. This method will be able to generate a feature matrix (deviation features) with the deviations. Also, the disclosure discloses a method for creating a validation neural network which trains on input and deviation features, whose predicted output, corrects the output from the AI/personalized model. This method facilitates in achieving dataset independence over conventional solutions.

Additionally, the disclosure provides for a system that may run a neural network on-device for a given AI/personalized model. The system also calculates the deviation from a default model to a personalized model on device, which is passed to the validation neural network for validation. This corrects/validates the AI/personalized model.

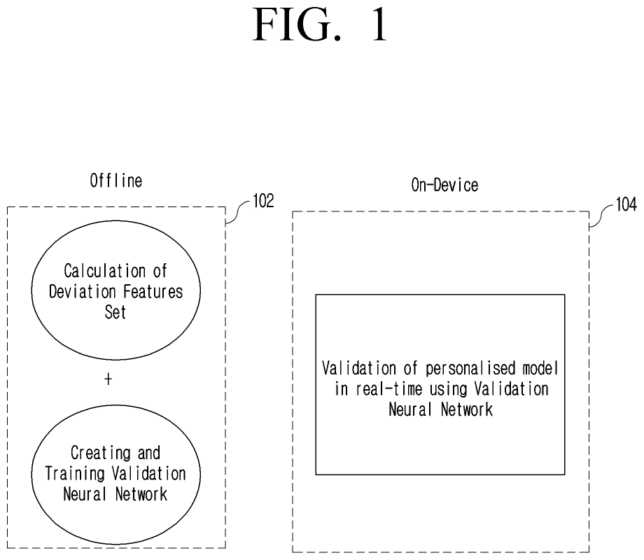

FIG. 1 illustrates a schematic block diagram for validating a trained artificial intelligence (AI) model on a device, according to an embodiment of the disclosure.

Referring to FIG. 1, in a block diagram, the solution comprises an offline phase 102 and an on-device or online phase 104. The offline phase 102 is directed towards calculation/determination of possible deviation features for the trained artificial intelligence model, and thereupon creating and training a validation neural network. The on-device/online phase 104 comprises of validation of the personalized model in real-time using the created validation neural network model. Specifically, the disclosure provides for an efficient light weight solution for on-device validation using a validation neural network and inverse mapping (not shown in FIG. 1), which focuses on independence of on-device dataset for validation. The validation neural network is created by applying at least in part the one or more possible configurational changes of the on-device artificial intelligence (AI)/deep neural network model requiring validation. The offline phase 102 and the online phase 104 are discussed in detail later throughout the disclosure.

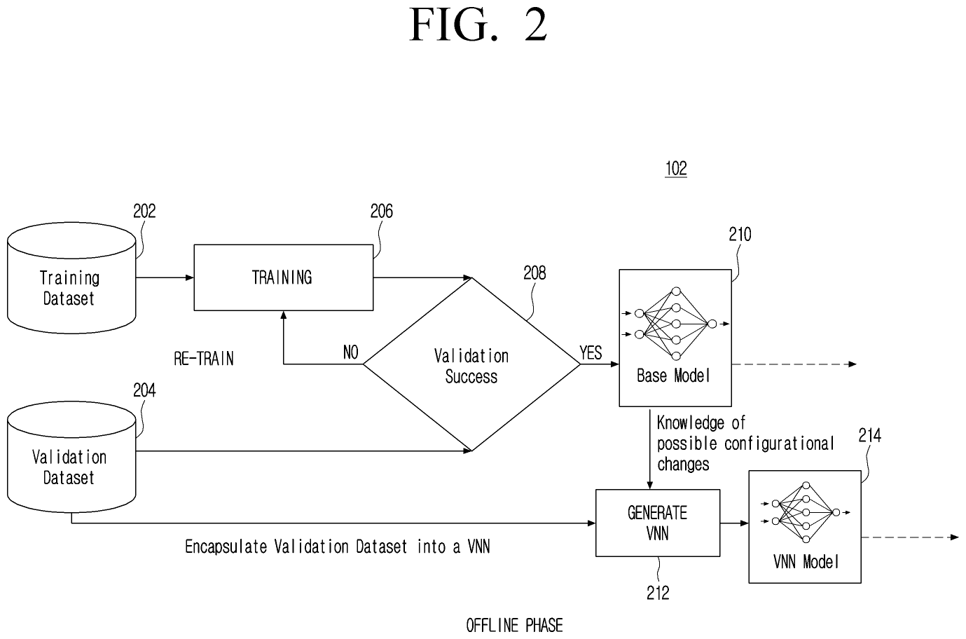

FIG. 2 illustrates a detailed schematic block diagram of an offline phase of generating a validation neural network for validating a trained artificial intelligence (AI) model on a device, according to an embodiment of the disclosure.

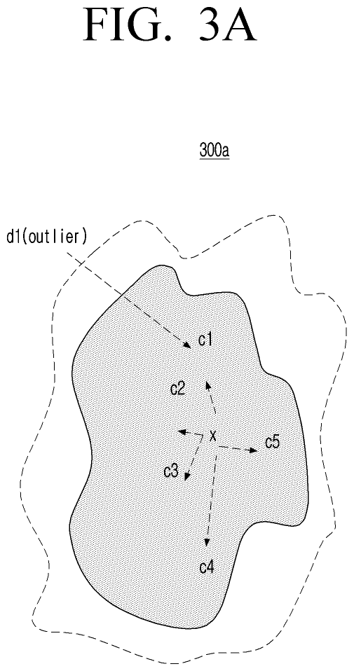

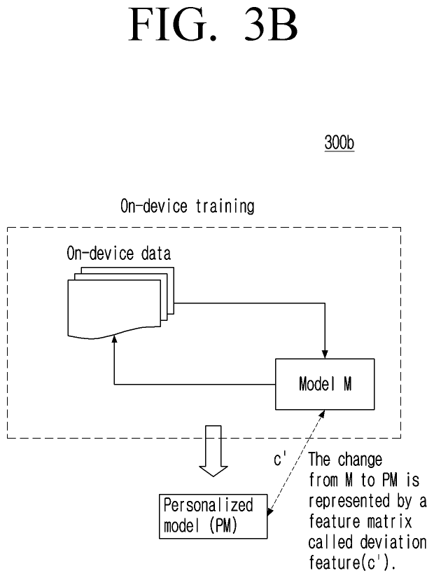

FIGS. 3A and 3B illustrate a schematic depiction of deviation feature set and an AI model changes, respectively, according to various embodiments of the disclosure.

FIGS. 2, 3A, and 3B are described in conjunction for ease of explanation.

Referring to FIG. 2, the base machine learning model 210 is generated based on a training dataset 202. The training dataset 202 represents data points that are used to train the base machine learning model 210. At operation 206, a training of the base machine learning model 210 may be performed. At operation 208, the trained base machine learning model 210 may be validated using validation dataset 204. If the validation is successful, a final version of the base machine learning model 210 may be output. In case of unsuccessful validation, a re-training may be performed at operation 206. Further, a set of known possible configurations (i.e., deviation features) may be determined to generate a validation neural network (VNN) 212 from the base machine learning model 210. Further, the validation dataset 204 may be encapsulated into the VNN. A VNN model 214 corresponding to the VNN 212 may be provided as an output of the offline phase 102.

During the current on-device training, only the last few layers of AI models are used for learning. The goal of on-device training is to achieve personalization and thereby creating a personalized machine learning model on the device from the base machine learning model 210. To create the personalized AI/ML model, an on-device training of just the last few layers may be sufficient. For example, in gallery tagging, by introducing trainable fully connected layer or convolution layers in the end may help in successfully achieving personalization in image classification.

In particular, in accordance with an embodiment, for personalization or the on-device training of the base AI/ML model, most of the base ML model 210 may be kept static, while just updating one or more parameters of last few layers. For example, in an image classification problem, the AI/ML models used are deep neural network (DNN) based models with convolution. These models take advantage of convolution layers and also have fully connected layers. If these two or any of the above is introduced in last layers and they may undergo training, the updating of weights of these models will reflect the personalization induced.

Thus, the overall deviation from personalization of the AI (i.e., the base machine learning) model is a finite space (change space). These spaces may be represented using discrete points, and these discrete points are termed as “deviation features”.

Referring to FIG. 3A, a set of deviation features 300a may include c1, c2, c3, c4, and c5. The set of these deviation features or the discrete points is called a deviation feature set, i.e., ci. Deviation features may be passed to a neural network for training. Based on this set of discrete points, a validation neural network (VNN) may be generated which quantifies a level of correction needed for a specific level of deviation of the AI personalized model. In-case a point (e.g., “x”) does not belong to the set, a distance measurement may be used to approximate to nearest element in the set. For a given model, the computation of this set of discrete points may be performed by analyzing/predicting the changes that the model may undergo during personalization on a device. In case the distance metric is too high, then it is compared with a predefined confidence parameter to classify it as outlier scenario (e.g., point d1).

More specifically, the representation of personalization is based on deviation feature(s). This deviation feature is a space vector which may be represented by a tensor. Accordingly, the deviation between the standard base model and the personalized model may be represented using a distance metric between the deviation features of standard model and the deviation feature of personalized model. For example, in an example of Euclidean metric, there are three models, i.e., a standard model (without personalization) called as M (deviation feature d—space vector denoting no change), an acceptable personalized model with accuracy as 80% called as PM1 (deviation feature d1) (Euclidean distance between d1 and d=ED1), and a non-acceptable personalized model with accuracy as 21% called as PM2 (deviation feature d2) (Euclidean distance between d2 and d=ED2). In case of a threshold of 50% accuracy, a vector space boundary may be defined after which deviation causes degradation of accuracy (results in <50%). This boundary may have a common-distance metric from the standard model, which may be ED. From the above case, it may be inferred using this distance metric instead of accuracy. It will be ED2>ED and ED1<ED. The same may be true with reverse signs, if inverse relation is established.

Referring to FIG. 3B, in an AI model changes 300b, a base AI model “M” at a device may undergo on-device training based on the on-device data. The on-device data may be associated with sensor data, or any other data received by the device. Thus, the AI model “M” may become a personalized model (PM) due to the on-device training. The change from the base AI model M to the personalized model PM may be represented by a feature matrix or deviation feature(s). Such deviation features from M to PM may belong to or may be approximated to the members of deviation feature set calculated during finite space creation in the offline stage, as discussed above.

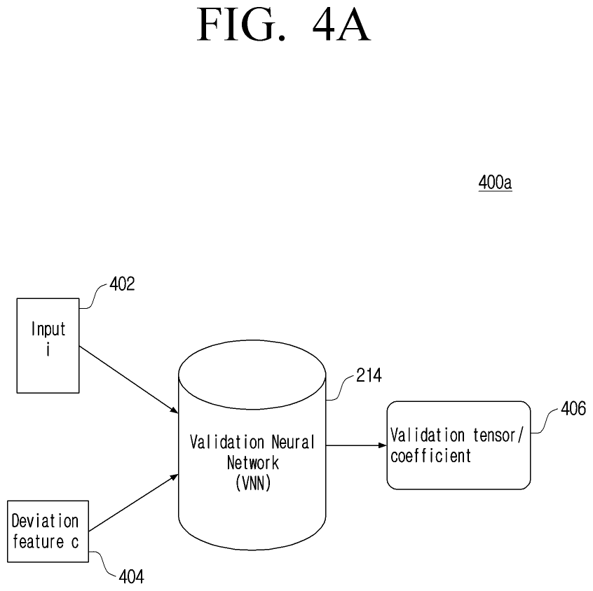

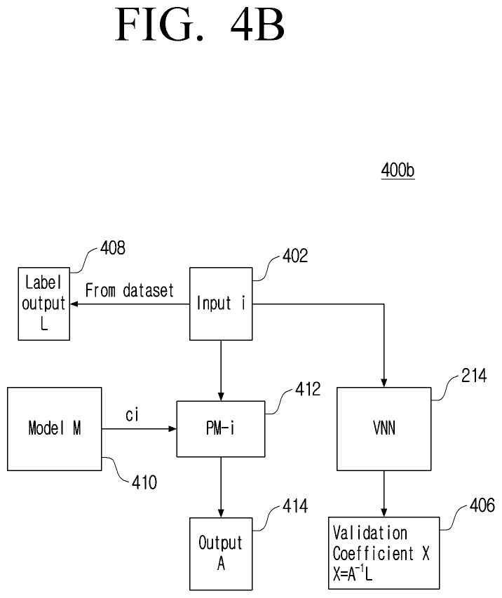

FIG. 4A illustrates a process flow for functioning of a validation neural network (VNN) model based on a set of deviation features, according to an embodiment of the disclosure.

FIG. 4B illustrates a validation neural network being used for validation of an AI model on a device, according to an embodiment of the disclosure.

Referring to FIG. 4A, in a process flow 400a, the VNN model 214 may be a neural network model which trains on input data 402 and deviation features 404. The input data 402 may be similar as the input data provided to the base machine learning/AI model. The input data 402 is used for mapping the relation of input and the deviation features to the validation coefficient/correction factor, as discussed later herein. Further, the VNN model 214, once deployed on the device where AI model is deployed, may be configured to provide an output validation tensor/coefficient 406 that is used to correct the output from the AI (personalized) model.

Referring to FIG. 4B, in a process flow 400b, the validation coefficient (X) 406 may be calculated via an inverse space mapping. Specifically, the inverse space mapping computes the X 406 by evaluating the value of inverse of output of the model M 410 which underwent a deviation along with label output L 408 for that given input data 402.

As depicted, the PM-i 412 may be the personalized model that after introducing the deviation represented by ci (i.e., deviation feature 404) to the primary deployed base machine learning/AI model (M) 410. “i” may an index that represents any deviation feature in the deviation feature set, while A⁻¹ is the mathematical inverse operation of a matrix of the output A 414. The output A 414 is an output obtained from the personalised model PM-i 412 in response to the input i 402 fed at the personalised model PM-i 412.

In particular, FIG. 4B represents training of the Validation Neural Network 214. The VNN 214 maps the relation between the validation coefficient X 406, labelled output L 408, and inverse of output A 414 of personalized model 412. The values of A and X may be determined in a step-by-step manner:

The first labelled output L 408 for input i may be obtained from an input i 402 to output mapping from the dataset. Subsequently, the output A 414 is calculated by passing input i 402 to the personalized model PM-i 412. The personalized model pm-i 412 is represented by deviation feature ci 404. Later, the value of X 406 may be determined using A⁻¹and labelled output L. Finally, the VNN 214 learns to relate input i to validation coefficient X 406.

Thus, the created VNN 214 may act as a real-time validator/corrector of output of the personalized AI model 412 during on-device deployment, while also facilitating dataset independence for validation.

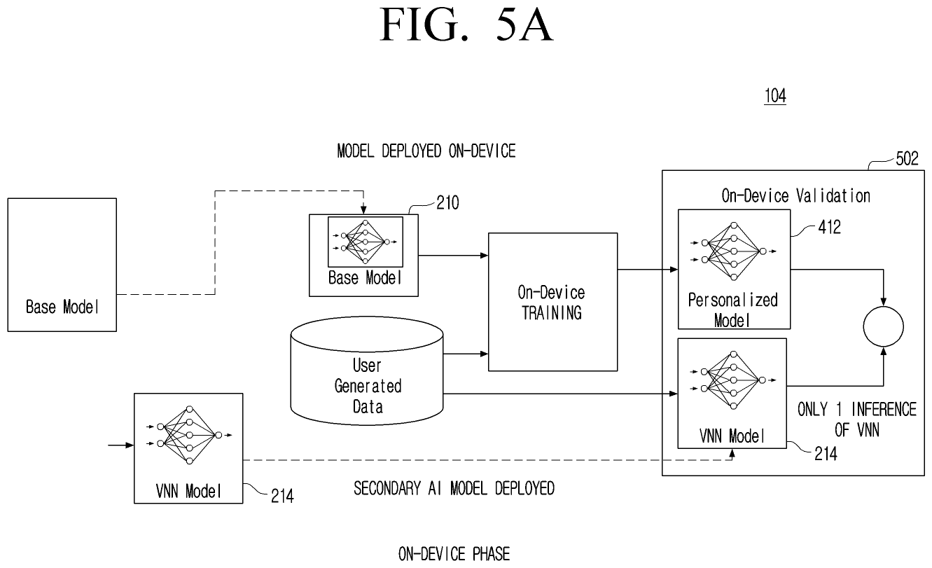

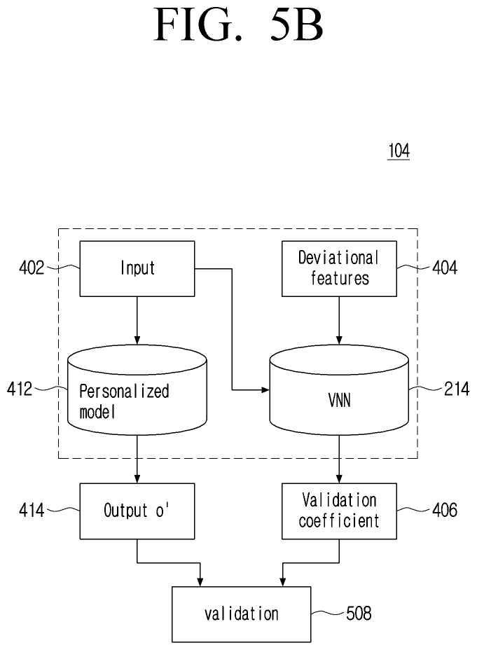

FIGS. 5A and 5B illustrate detailed schematic block diagram comprising a workflow of an on-device/online phase of validating a training of an artificial intelligence (AI) model deployed on a device, according to various embodiments of the disclosure.

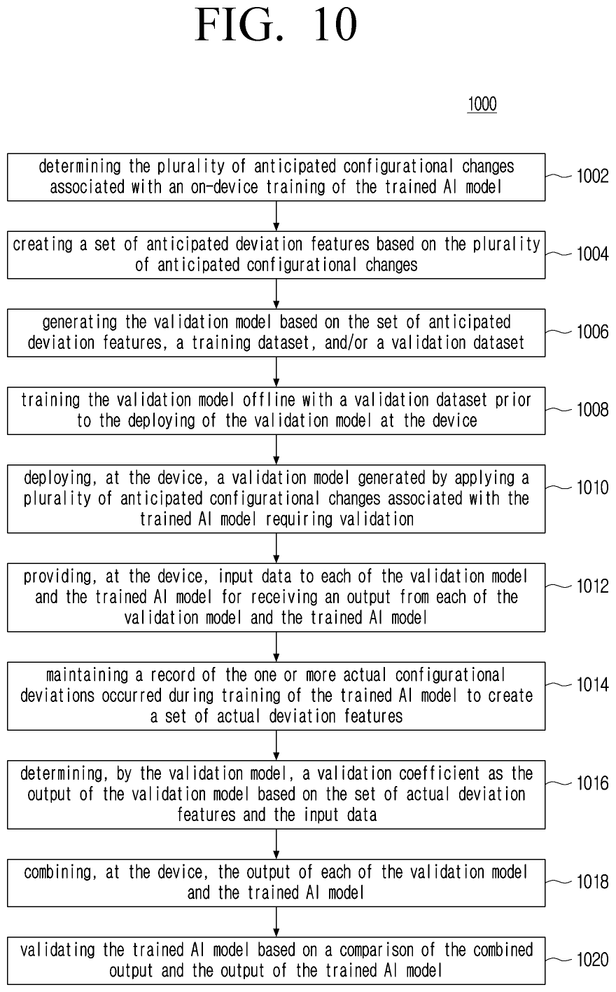

Referring to FIGS. 5A and 5B, for any given device, a deployed AI model undergoes changes (from personalization) to form a personalised model 412 that is represented by a set of deviation features 404 as discussed previously. The changed model is called a personalized model 412. In one embodiment, these deviation features and the input dataset is passed to the VNN 214 deployed on the device 502 to obtain a validation coefficient (X) 406. Also, the input dataset 402 may be provided to the personalized AI model 412 which provides an output o′ or A 414. Subsequently, for validation 508 of the output (o′) 414 of the personalized model 412, the validation coefficient (X) 406 is multiplied/combined with the output (o′) 414 from the personalized model 412 to get the corrected output. The output of this combination is used for validation 508. However, no dataset is required for validation of the output (o′) of the personalized model. In one embodiment, the output (o′) 414 from the personalized model 412 is compared with a correct output (not shown) using empirical evaluation such as, but not limited to, mean absolute error, which may determine if the personalized model 412 is performing good or bad. The process of validation 508 is also discussed in detail in conjunction with FIG. 10 later.

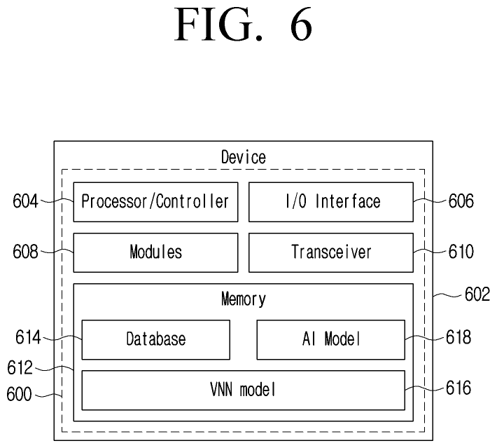

FIG. 6 illustrates a schematic block diagram of a system for validating training of an artificial intelligence (AI) model deployed on a device, according to an embodiment of the disclosure.

Referring to FIG. 6, a system 600 may be included within a device 602 capable of operating with a neural network or artificial intelligence-based models. For example, the system 600 is included within a mobile device or an IoT device. Examples of mobile device 602 include, but are not limited to, a mobile phone, a smart watch, a tablet, a laptop, a smart refrigerator, a smart AC, a smart coffee machine, or any other electronic device capable of operating with a neural network-based model. In other embodiments, the system 600 may be configured to operate as a standalone a system residing within a cloud-based network. In an embodiment of the disclosure, the online phase may be implemented on system 600. As a person skilled in the art would appreciate, the offline phase may be performed on a similar system 600 provided on another device or a server or a cloud-based network.

In various embodiments of the disclosure, the system 600 may be configured to validate an AI model 618 deployed on the device 602. The AI model 618 may be configured to perform one or more artificial intelligence tasks such as processing data received at the device (e.g., from one or more sensors (not shown) in device 602) to provide intelligent outputs. The AI model 618 may be any neural network-based model which is capable of learning over a period of time based on on-device training using user data. The system 600 may further include a processor/controller 604, an input/output (I/O) interface 606, modules 608, transceiver 610, and a memory 612.

In some embodiments, the memory 612 may be communicatively coupled to the at least one processor/controller 604. The memory 612 may be configured to store data, instructions executable by the at least one processor/controller 604. In some embodiments, the modules 608 may be included within the memory 612. The memory 612 may further include a database 614 to store data. The one or more modules 608 may include a set of instructions that may be executed to cause the system 600 to perform any one or more of the methods disclosed herein. The one or more modules 608 may be configured to perform the steps of the disclosure using the data stored in the database 614, to validate training of the AI model 618 using a VNN model 616. In an embodiment, each of the one or more modules 608 may be a hardware unit which may be outside the memory 612. The transceiver 610 may be capable of receiving and transmitting signals to and from the device 602. The I/O interface 606 may include a display interface, a speaker, and/or a microphone to receive inputs and provide output to a user of the device 602. Further, the I/O interface 606 may provide a display function and one or more physical buttons on the device 602 to input/output various functions of the device 602. For the sake of brevity, the architecture and standard operations of memory 612, database 614, processor/controller 604, transceiver 610, and I/O interface 606 are not discussed in detail. In one embodiment, the database 614 may be configured to store the information as required by the one or more modules 608 and processor/controller 604 to perform validation of training of the AI model 618 using the VNN model 616.

In one embodiment, the memory 612 may communicate via a bus within the system 600. The memory 612 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 612 include a cache or random-access memory for the processor/controller 604. In alternative examples, the memory 612 is separate from the processor/controller 604, such as a cache memory of a processor, the system memory, or other memory. The memory 612 may be an external storage device or database for storing data. The memory 612 may be operable to store instructions executable by the processor/controller 604. The functions, acts or tasks illustrated in the figures or described may be performed by the programmed processor/controller 604 for executing the instructions stored in the memory 612. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

Further, the disclosure contemplates a computer-readable medium that includes instructions or receives and executes instructions responsive to a propagated signal, so that a device connected to a network may communicate voice, video, audio, images, or any other data over a network. Further, the instructions may be transmitted or received over the network via a communication port or interface or using a bus (not shown). The communication port or interface may be a part of the processor/controller 604 or maybe a separate component. The communication port may be created in software or maybe a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 600 may be physical or may be established wirelessly. The network may alternatively be directly connected to the bus.

In one embodiment, the processor/controller 604 may include at least one data processor for executing processes in Virtual Storage Area Network. The processor/controller 604 may include specialized processing units such as, integrated system (bus) controllers, memory management control units, floating point units, graphics processing units, digital signal processing units, and the like. In one embodiment, the processor/controller 604 may include a central processing unit (CPU), a graphics processing unit (GPU), or both. The processor/controller 604 may be one or more general processors, digital signal processors, application-specific integrated circuits, field-programmable gate arrays, servers, networks, digital circuits, analog circuits, combinations thereof, or other now known or later developed devices for analyzing and processing data. The processor/controller 604 may implement a software program, such as code generated manually (i.e., programmed).

The processor/controller 604 may be disposed in communication with one or more input/output (I/O) devices via the I/O interface 606. The I/O interface 606 may employ communication code-division multiple access (CDMA), high-speed packet access (HSPA+), global system for mobile communications (GSM), long-term evolution (LTE), worldwide interoperability for microwave access (WiMax), or the like.

Using the I/O interface 606 (e.g., an input device), the device 602 may be configured to receive and deploy AI model 618 and VNN model 616. For example, the input device is an antenna, microphone, touch screen, touchpad, storage device, transceiver, video device/source, and the like. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED), or the like), audio speaker, and the like.

The processor/controller 604 may be disposed in communication with a communication network via a network interface. The network interface may be the I/O interface 606. The network interface may connect to a communication network. The network interface may employ connection protocols including, without limitation, direct connect, Ethernet (e.g., twisted pair 10/100/1000 Base T), transmission control protocol/Internet protocol (TCP/IP), token ring, Institute of Electrical and Electronics Engineers (IEEE) 802.11a/b/g/n/x, and the like. The communication network may include, without limitation, a direct interconnection, local area network (LAN), wide area network (WAN), wireless network (e.g., using Wireless Application Protocol), the Internet, and the like. Using the network interface and the communication network, the device 602 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, and the like.

At least one of the plurality of modules 608, the AI model 618, and/or the VNN may be implemented through an AI based model. A function associated with AI may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning technique to a plurality of learning data, a predefined operating rule or AI based model of a desired characteristic is made. The learning may be performed in a device itself in which AI according to an embodiment is performed, and/or may be implemented through a separate server/system.

The AI based model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for validating training of an artificial intelligence (AI) model deployed on a device. Examples of learning techniques include, but are not limited to, supervised learning, unsupervised learning, semi-supervised learning, or reinforcement learning.

According to the disclosure, the method of validating training of an artificial intelligence (AI) model deployed on a device may use an artificial intelligence model to recommend/execute the plurality of instructions. The processor may perform a pre-processing operation on the data to convert into a form appropriate for use as an input for the artificial intelligence model. The artificial intelligence model may be obtained by training. “Obtained by training” means that a predefined operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction is a technique of logically reasoning and predicting by determining information and includes, e.g., knowledge-based reasoning, optimization prediction, preference-based planning, or recommendation.

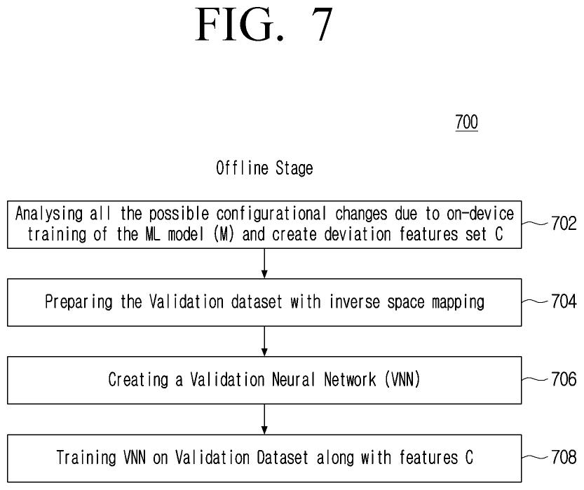

FIG. 7 illustrates a detailed process flow depicting a method for an offline phase of generating a validation neural network for validating a trained artificial intelligence (AI) model on a device, according to an embodiment of the disclosure.

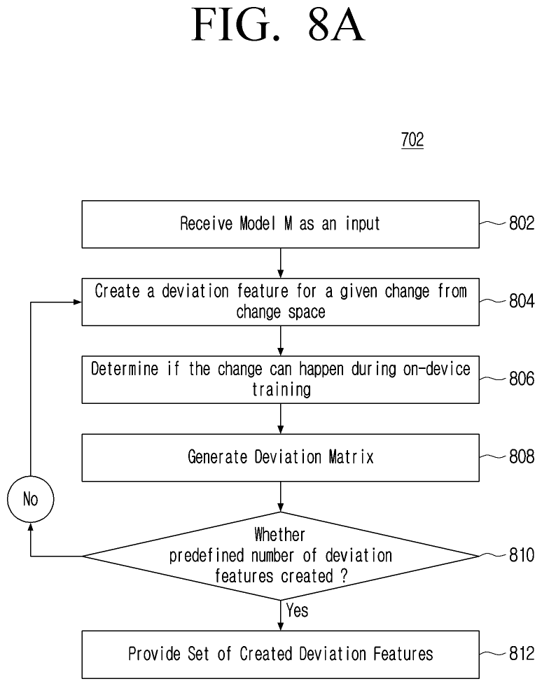

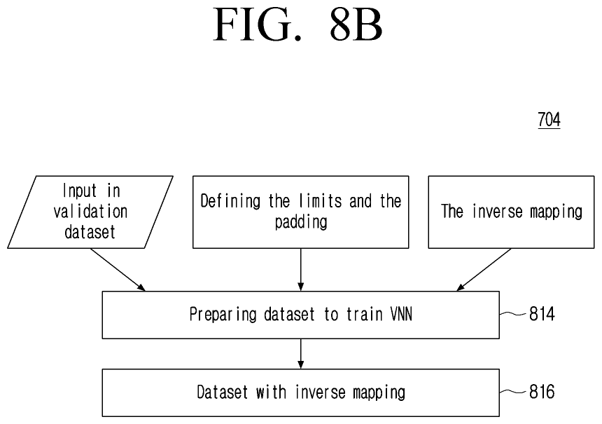

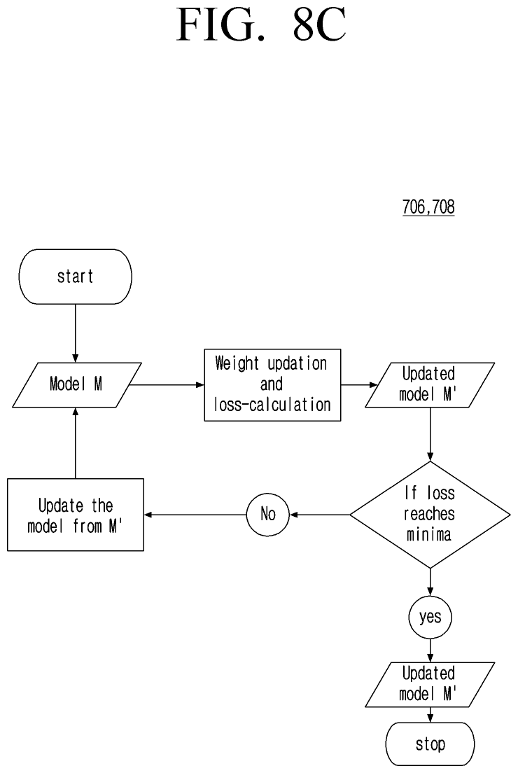

FIGS. 8A, 8B, and 8C illustrate a more detailed process flow depicting a method for each sub-step of method for an offline phase of generating a validation neural network for validating a trained artificial intelligence (AI) model on a device, according to various embodiments of the disclosure. FIGS. 7 and 8A to 8C are described in conjunction with each other for sake of brevity.

Referring to FIG. 7, at operation 702, a method 700 comprises analyzing all the possible configurational changes due to on-device training of the ML model (M) and create deviation features set C. This operation is illustrated in detail in conjunction with FIG. 8A.

As discussed above, a deployed AI Model “M” may undergo configurational changes during on-device training that represents the personalization. Referring to FIG. 8A, for analyzing all the possible configurational changes, the personalized model M is provided as an input at an offline system (e.g., similar to system 600) at operation 802. At operation 804, the personalized model M may be analyzed, and a change space may be created that defines these changes. This change space may be represented by discrete points or deviation features. These deviation features indicate the changes that may happen during on-device training of the model M. Further, at operation 806, based on a determination that a change may happen during on-device training of model M, a deviation matrix may be generated at operation 808. Furthermore, at operation 810, it may be determined whether a predefined number of deviation features are created. If yes, then the method may provide a set of deviation features as an output at operation 812. Otherwise, the method may move to operation 804 to repeat the steps of creating more deviation features. The generated set of deviation features (i.e., the change space) may be used to create the Validation Neural Network (VNN), and thereby the VNN model.

In an embodiment, the change space may also be relative to a use-case team. This can be done theoretically and empirically. As an example, for empirical method, the use-case team conducts a beta testing to obtain a sample of personalised model. The deviation feature may be calculated for each personalized model to the base model that can be represented as vector space (i.e., vector, tensor or any other mathematical tool). This defines the change space.

At operation 704, the method 700 comprises preparing the validation dataset with inverse space mapping. As it may be understood, the inverse space mapping is merely exemplary, and several other techniques may be used for preparation of validation dataset. This operation is illustrated in detail in conjunction with FIG. 8B.

Referring to FIG. 8B, at operation 814, the method comprises preparing dataset to train the VNN, and a dataset with inverse mapping may be output at operation 816. The given data from the validation dataset may be a mapping from the input to label output, but this needs to be updated to train the Validation Neural Network. The label output is the ground truth that represents correct value in an annotated database. For a given input I and given output A from the model M′ (where M′ is one of the variations of Model M obtained from pre-computation) with label output O, an inverse value (x) may be calculated such that X=A⁻¹O.

For every supervised Machine Learning, an AI model is trained upon the annotated database. The annotated database is where there is mapping of input features to output value (ground truth). The correct value for a given input may be obtained from the annotated database.

The inverse value X is the correction factor for the output from the personalized model. The VNN tries to predict this value from input and deviation feature. Then mapping of I->X is generated across the dataset. While calculating the inverse of A, there are conditions that the A should have square shape and determinant of A(|A|) should not be zero. The inverse mapping is the process of learning mapping between the input and deviation feature and relate it to the correction factor.

If the actual output of A is not a square matrix, then padding process should be included in this operation to convert it into a desired shape. The values in the padding may be zero, random, or based on some heuristic or empirical evaluation.

Next condition is if |A|=0, that is adjoint(A)/|A| doesn't become undefined. So, to prevent it, whenever this happens, limit for this may be defined.

$${lim}_{\vert A \vert \to 0} {( \frac{1}{\vert A \vert} )}^{1} = ∞ ,$$

so, the ∞ will be max_value_k for the use-case, which can be constant or obtained from heuristics or empirical evaluation.

At operation 706, the method 700 comprises creating a Validation Neural Network (VNN). At operation 708, the method 700 comprises training VNN on Validation Dataset along with deviations feature set C. These operations 706 and 708 are illustrated in detail in conjunction with FIG. 8C.

Specifically, the operation 706 is associated with creating a neural network to learn on the previous operation for each deviation feature (c a) in deviation feature set C over multiple iterations. In one embodiment, the to-be-created neural network (i.e., the validation neural network) should map an input and deviation feature to the correction factor needed for the base model (i.e., deployed on device for personalization) with passed deviation feature. The VNN created at operation 706 should be trained with dataset prepared in the previous operation using inverse space mapping. The VNN may be any lightweight Neural Network, since it is not bound by KPI for matching the output value, and acts as a validation factor which is lenient as it acts as base for threshold for acceptancy.

The lightweight model corresponds to a model requiring less memory, computation power, and which may run smoothly on edge devices. In one or more embodiments, the size of lightweight validation neural network model may be between 1-50 MBs, while the execution time may in a range of 1 ms to 500 ms. As it may be understood, the above specified size and the execution time for the lightweight validation neural network model are merely exemplary and may not be limited to such values. The KPI may be a key performance indicator, which is usually the inference time, accuracy requirements that a use-case may have. Since VNN is independent of use-case execution, this doesn't affect the process and is an advantage. This does not have a stringent requirement of 95% accuracy which is for most use-cases. For example, even if threshold is 60% for VNN, it is enough for validation, but same accuracy for a use-case validation may give bad results.

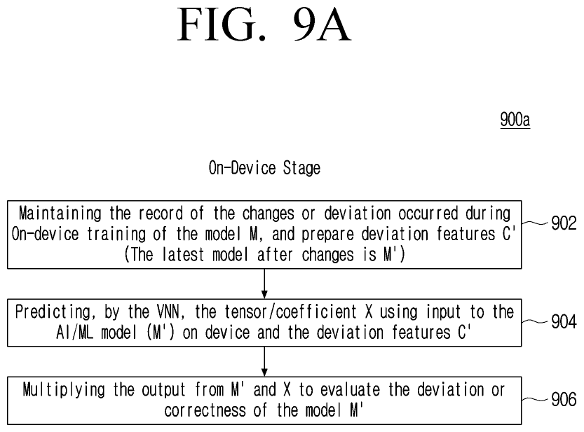

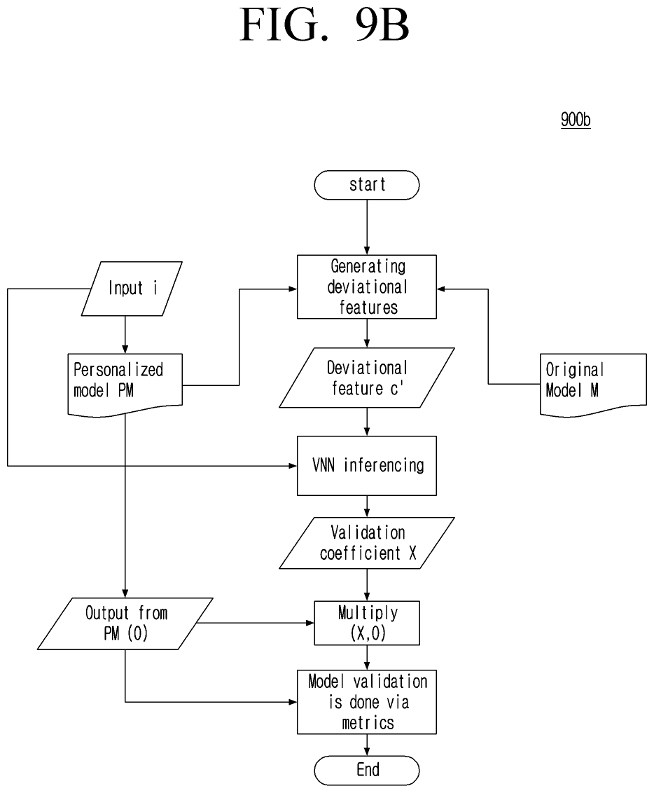

FIGS. 9A and 9B illustrate detailed process flows depicting methods, respectively, of the online or on-device phase of validating a training of an artificial intelligence (AI) model deployed on a device, according to various embodiments of the disclosure.

Referring to FIG. 9A, at operation 902, a method 900a comprises maintaining the record of the changes or deviation occurred during on-device training of the model M and create deviation features C′. The Model M is deployed in the smart embedded/mobile devices, where the model M undergoes configurational changes by on-device training on personal data from device. These configurational changes results in a personalized model (PML). These changes from M to PML may be computed. From these changes, the deviation features (C′) will be generated. This set of deviation features C′ will belong to the set created during offline phase (C).

The changes from M to PML may also be relative to the use-case team. In general, the use-case team may perform an on-device training on weights on a particular layer. The weights may be represented as tensor (vector space or by mathematical tools). The difference between weights of the base model and the personalized model may be used to represent the changes. The difference can also be simplified via ML distance metrics.

At operation 904, the method 900a comprises predicting, by the VNN, the tensor/coefficient X using input to the AI/ML model (M′) on device and the deviation features C′.

Specifically, the deviation feature C′ along with the input to the model M′ are passed to the Validation Neural Network (VNN) to inference the Validation Coefficient (X). This X when multiplied with the inferenced output from the model M′ will provide the labelled output from validation dataset used in offline phase. The inferenced output from the model M′ will undergo same processing if the output is not square shaped or if determinant is zero mentioned in the offline phase.

At operation 906, the method 900a comprises multiplying the output from M′ and X to evaluate the deviation or correctness of the model M′. Multiplying is a function that calculates the approximate ground truth using correction factor X and output M′ from the personalized model. This is then used for validation.

Specifically, at this operation 906, a real time on-device validation is performed for the model M′. The output (Oi) from the personalized model (M′) for given input i is inferenced. Further, the output (X) from the VNN for given input i and the deviation feature C′ representing the personalization of model M to M′ is inferenced. Subsequently, the output X is multiplied with Oi to get the corrected output Lv.

The difference between Oi and Lv is calculated which represents the degree of shift from the normal value. This difference is used to confirm whether the personalization is valid or not. The output Oi provides the relationship between the input and personalization. Further, the output X provides an indication of an estimated correction required for personalized output, by considering the deviation caused. In one embodiment, the metrics that may be used to check the difference between Lv and Oi include, but not limited to, mean absolute error (MAE) and relative error.

FIG. 10 illustrates a detailed process flow depicting a method of the offline and online phases for validating a training of an artificial intelligence (AI) model deployed on a device, according to an embodiment of the disclosure.

Referring to FIG. 10, at operation 1002, a method 1000 comprises determining the plurality of anticipated configurational changes associated with an on-device training of the trained AI model.

At operation 1004, the method 1000 comprises creating a set of anticipated deviation features based on the plurality of anticipated configurational changes.

At operation 1006, the method 1000 comprises generating the validation model based on the set of anticipated deviation features, a training dataset, and/or a validation dataset. The validation model may be generated prior to the deployment of the validation model at the device.

In one or more embodiments, generating the validation model comprises generating the validation model based on the training of the validation model with the validation dataset generated using an inverse space mapping technique.

At operation 1008, the method 1000 comprises training the validation model offline with a validation dataset prior to the deploying of the validation model at the device.

At operation 1010, the method 1000 comprises deploying, at the device, a validation model generated by applying a plurality of anticipated configurational changes associated with the trained AI model requiring validation.

At operation 1012, the method 1000 comprises providing, at the device, input data to each of the validation model and the trained AI model for receiving an output from each of the validation model and the trained AI model.

At operation 1014, the method 1000 comprises maintaining a record of the one or more actual configurational deviations occurred during training of the trained AI model to create a set of actual deviation features. In one or more embodiments, the set of actual deviation features is a subset of the anticipated deviation features.

At operation 1016, the method 1000 comprises determining, by the validation model, a validation coefficient as the output of the validation model based on the set of actual deviation features and the input data.

At operation 1018, the method 1000 comprises combining, at the device, the output of each of the validation model and the trained AI model. In one or more embodiments, the combining comprises combining the validation coefficient of the validation model and the output of the trained AI model to generate a corrected output for the trained AI model.

At operation 1020, the method 1000 comprises validating the trained AI model based on a comparison of the combined output and the output of the trained AI model.

In an embodiment, validating the trained AI model may include determining a difference between the combined output and the output of the trained AI model. Specifically, determining the difference may include determining the difference based on one of an error function between the combined output and the output of the trained AI model. Further, the difference may be compared with a predefined threshold to validate the trained AI model.

In one embodiment, the validating may further comprise one of successfully or unsuccessfully validating the trained AI model in response to determining whether the difference between the combined output and the output of the trained AI model is one of higher or lower than a predefined threshold. In response to successfully validating the trained AI mode, a final version of the base (i.e., trained) machine learning model may be output. In response to unsuccessfully validating the trained AI model, one of retraining or discarding training of the trained AI model may be performed.

In one or more embodiments, the validating may comprise validating, in real-time, the trained AI model using the validation model without storage of validation dataset on the device.

The above steps are not discussed in detail for the sake of brevity, since these have been discussed in detail with respect to FIGS. 1, 2, 3A, 3B, 4A, 4B, 5A, 5B, 6, 7, 8A to 8C, 9A, and 9B of the disclosure.

While the above steps are shown in FIGS. 7, 8A to 8C, 9A, 9B, and 10 and described in a particular sequence, the steps may occur in variations to the sequence in accordance with various embodiments of the disclosure. Further, the details related to various steps of FIG. 10, which are already covered in the description related to FIGS. 1, 2, 3A, 3B, 4A, 4B, 5A, 5B, 6, 7, 8A to 8C, 9A, and 9B are not discussed again in detail here for the sake of brevity.

At least by virtue of aforesaid, the subject matter at least provides the following advantages:

In the existing solutions, the validation is performed via a local validation dataset pushed into a device (dataset dependent), or by sending the model to a third party or centralized server for validation (privacy concerns). The disclosure is dataset independent and does not require any third-party validation system or any human intervention. Since, the method of the disclosure does not require user-data to be sent to third-party or a centralized server, thus reducing the vulnerability of user-data to breaches. In other words, in the disclosure, the methodology does not need of any transfer of user generated data or model. Offline server phase has only purpose, that is to generate a model based on offline validation dataset and offline calculation of variation of the model.

The disclosure of validation of AI models is applicable in various mobile devices, wearables, drones, IoT sensors/micro controllers, where there is a need for an on-device validation system. Further, the disclosure is effective with respect to memory reduction, since the solution proposes data-set independent validation on device. The solution is light-weight and suitable for edge devices. Thus, the disclosure is associated with a system which is on-device dataset independent, thus reducing a need for huge memory. Further, the Validation Neural Network is a lightweight neural network for edge devices, so the power consumption, memory and processing power required is lesser as compared to existing solutions. Furthermore, the Validation Neural network gives a correction factor, and also re-uses the output from the personalized model, adding to efficiency during on-device inferencing in real-time. Since the Validation Neural network is an independent entity, it may be updated anytime during deployment, thus making it more flexible, updatable and may improve over time.

Additionally, the prior art solutions provide a method which use virtual peripheral device for executing verification for the on-device AI models. Therefore, the verification is performed on the virtual machine instance in the cloud which stores the user generated data outside the user-device, which is highly susceptible to breach, whereas the disclosure provides a method where two AI model are inferenced locally on a device, and where one AI model acts as validator for the other and no storage of output is involved externally. Therefore, the disclosure is free of any privacy concerns.

Additionally, in the prior art solutions, the output from users may be stored and then compared with the standard validation dataset on a server, whereas in the proposed disclosure, a new way of validation of AI model based on various deviations on the AI model and the data from the user to validate on-device training is provided. Thus, the proposed method is dataset independent for validation.

Further, the prior art solutions which are implemented on the server require cloud based virtual devices (input, output) which is created by another device called a peripheral device handler and require the output to be stored in memory, which will be used for verification, whereas in the disclosure, no additional hardware or cloud-based components are to be added to the device and the validation computation is done in real time.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for validating a trained artificial intelligence (AI) model on a device, the method comprising:
deploying, at the device, a validation model generated by applying a plurality of anticipated configurational changes associated with the trained AI model requiring validation;
providing, at the device, input data to each of the validation model and the trained AI model for receiving an output from each of the validation model and the trained AI model, the output of the validation model being further based on one or more actual configurational deviations that occurred during training of the trained AI model since deployment of the trained AI model on the device;
combining, at the device, the output of each of the validation model and the trained AI model; and
validating the trained AI model based on a comparison of the combined output and the output of the trained AI model.

2. The method as claimed in claim 1, comprising:
generating, at the device or outside the device, the validation model based on a training dataset and a validation dataset, prior to the deploying of the validation model at the device.

3. The method as claimed in claim 1, wherein the validating of the trained AI model comprises one of successfully or unsuccessfully validating the trained AI model in response to determining whether a difference between the combined output and the output of the trained AI model is one of higher or lower than a predefined threshold.

4. The method as claimed in claim 3, comprising:
one of retraining or discarding training of the trained AI model in response to unsuccessfully validating the trained AI model.

5. The method as claimed in claim 1, wherein the validating of the trained AI model comprises validating, in real-time, the trained AI model using the validation model without storage of validation dataset on the device.

6. The method as claimed in claim 1, comprising:
determining the plurality of anticipated configurational changes associated with an on-device training of the trained AI model;
creating a set of anticipated deviation features based on the plurality of anticipated configurational changes; and
generating the validation model based on the set of anticipated deviation features.

7. The method as claimed in claim 6, comprising:
training the validation model offline with a validation dataset prior to the deploying of the validation model at the device.

8. The method as claimed in claim 7, wherein generating the validation model comprises generating the validation model based on the training of the validation model with the validation dataset generated using an inverse space mapping technique.

9. The method as claimed in claim 1, comprising:
maintaining a record of the one or more actual configurational deviations occurred during training of the trained AI model to create a set of actual deviation features, the set of actual deviation features being a subset of a set of anticipated deviation features; and
determining, by the validation model, a validation coefficient as the output of the validation model based on the set of actual deviation features and the input data,
wherein the combining comprises combining the validation coefficient of the validation model and the output of the trained AI model to generate a corrected output for the trained AI model.

10. The method as claimed in claim 1, wherein validating of the trained AI model comprises:
determining a difference between the combined output and the output of the trained AI model; and
comparing the difference with a predefined threshold to validate the trained AI model.

11. The method as claimed in claim 10, wherein determining of the difference comprises determining the difference based on one of an error function between the combined output and the output of the trained AI model.

12. A system for validating a trained artificial intelligence (AI) model on a device, the system comprising:
a validation model; and
at least one processor, wherein the at least one processor is configured to:
deploy, at the device, the validation model created by applying a plurality of anticipated configurational changes associated with the trained AI model requiring validation,
provide, at the device, input data to each of the validation model and the trained AI model for receiving an output from each of the validation model and the trained AI model, wherein the output of the validation model is further based on a set of actual configurational deviations that occurred during training of the trained AI model since deployment of the trained AI model on the device,
combine, at the device, the output of each of the validation model and the trained AI model, and
validate the trained AI model based on a comparison of the combined output and the output of the trained AI model.

13. The system as claimed in claim 12, wherein the at least one processor is further configured to:
generate, at the device or outside the device, the validation model based on a training dataset and a validation dataset, prior to the deploying of the validation model at the device.

14. The system as claimed in claim 12, wherein to validate the trained AI model, the at least one processor is further configured to one of successfully or unsuccessfully validate the trained AI model in response to determining whether the difference between the combined output and the output of the trained AI model is one of higher or lower than a predefined threshold.

15. The system as claimed in claim 12, wherein the validation is performed by at least one of a local validation dataset pushed into the device or by transmitting the model to a third party or centralized server for validation.

16. The system as claimed in claim 12, wherein the output of each validation model is inferenced.

17. The system as claimed in claim 12, wherein the at least one processor is further configured to:
maintain a record of the changes or deviations that occurred during on-device training of the validation model.

18. A non-transitory computer readable recording medium including a program executes a controlling method for validating a trained artificial intelligence (AI) model on a device, the method comprising:
deploying, at the device, a validation model generated by applying a plurality of anticipated configurational changes associated with the trained AI model requiring validation;
providing, at the device, input data to each of the validation model and the trained AI model for receiving an output from each of the validation model and the trained AI model, wherein the output of the validation model is further based on one or more actual configurational deviations that occurred during training of the trained AI model since deployment of the trained AI model on the device;
combining, at the device, the output of each of the validation model and the trained AI model; and
validating the trained AI model based on a comparison of the combined output and the output of the trained AI model.
